(19) United States
(12) Patent Application Publication
(10) Pub. No.: US 2006/0072731 A1
(43) Pub. Date: Apr. 6, 2006

(54) SELECTIVE TELEPHONY FUNCTIONS

(76) Inventors: Per Hallberg, SE-740 20 Vange (SE); Tor-Bjorn Hallberg, SE-740 20 Vange (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/711,804

(22) Filed: Oct. 6, 2004

(51) Int. Cl. H04M 3/42

(52) U.S. Cl. 379/210.02

(57) ABSTRACT

Method and system for reachability via time controls to a selective register. This is achieved by the fact that the identity of the calling number from other subscribers to the first subscriber, that via time controls are permitted to be forwarded to a register that corresponds to the identity of the number of the caller, and can according to the invention provide selective messages in an unlimited amount to the call and selectively forward subscribers to selective registers. The time control is a first function that the caller is encountering. Via the time control the identity of the caller can lead to ranked registers such as message registers at a first level and thereafter to other selected registers that corresponds to the identity of the caller. As a last function the call may be let through to the first subscriber assuming that the time control is so arranged.

### TECHNICAL FIELD

The present invention relates to a method and system for selectively letting through of telephone calls to a first subscriber.

### BACKGROUND OF THE INVENTION

Telephone subscribers want to be able to control incoming calls with different functions without having to necessarily add on additional services to the telephone subscription. Many unwanted calls may be directed to a first subscriber. The subscriber may not be able to handle these in a good way. The subscriber stills wants to be reachable and to get in direct contact with one or many members in one or many groups.

According to the present invention, the first subscriber may avoid unwanted calls completely or partially depending upon which status the first subscriber assigns each caller. This should be achievable without obtaining confidential numbers that may be obtained in different ways.

Another way that is used is to assign codes and similar information to selected callers so that calls are let through and that the first subscriber has a code reader that only lets through calls that have been preceded with a code that is stored in a list. The first subscriber must establish a register for who has the codes and continuously update this. Another problem is that the party with the code must keep track of the code. Another drawback is that code systems are limited because the first subscriber must be able to predict who is going to call and have important messages. It would of course be better if the fist subscriber could determine which parties that are permitted to be let through to the first subscriber without having to inform the desirable caller in advance.

### SUMMARY OF THE INVENTION

One object of the present invention is to devise a selection-technique for letting calls through to a first subscriber from one or many predetermined groups of other subscribers so that the selection technique does not require providing these other subscribers with codes in order to reach the first subscriber.

The invention takes advantage of adding identity information to the incoming signal of the other caller that can be read by the first subscriber before the call is let through.

The invention also uses one or many registers that the first subscriber may establish for numbers of other subscribers that are to be let through. This register can work so that all subscribers in the list are not let through to the first subscriber or are only let through during certain time periods to one of many registers (message register, let-through registers etc.). The registers may also work so that all the listed subscribers are let through at least during certain time periods.

Many different registers may be established so that the first subscriber can select which register is temporarily active or the subscriber can select many active registers during certain time periods or select so that all callers, who send signals that include information about the identity of the caller are let through.

The first subscriber may have prepared messages and forwarding functions to selectively or group-wise send the calls to registers that have been established for the incoming calls.

The invention may in a simple form only block calls that are not identifiable and thus include telephone numbers that may be identified. Additionally, the invention includes an additional register for allowed subscribers. The system has a comparator arrangement that is arranged to let through calls from identified subscriber telephone numbers included in the register. The system may not only be implemented with a separate arrangement but also be built into the telephone or be available from the telephone operator.

The registers may be directly programmed by the first subscriber. The invention is described in connection with telephone calls but it is to be understood that the invention includes all telephone communication or signaling communication in general and includes all signaling arrangements.

### BRIEF DESCRIPTION OF THE DRAWINGS

Examples of the invention are illustrated in the appended drawings of which:

FIG. 1 is a schematic view of a first embodiment of a system of the present invention;

FIG. 2 is a schematic view of a second embodiment of the system of the present invention; and

FIG. 3 is a schematic view of both the first and second embodiments integrated into one drawing.

### DETAILED DESCRIPTION

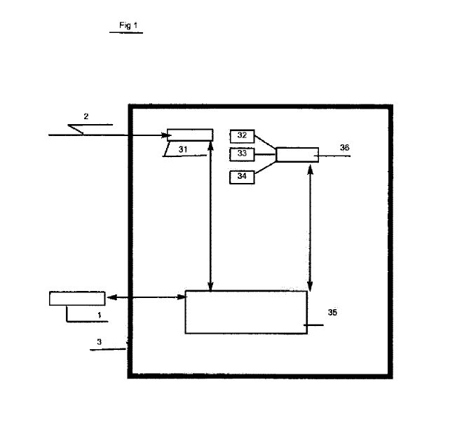

FIG. 1 shows a conventional telephone 1 of a first subscriber and is schematically illustrated as having an incoming signal 2 via a telephony network. The signal 2 is assumed to include information about the identity of the caller. An apparatus 3 according to the present invention is connected between the telephony network and the telephone 1 of the first subscriber. The apparatus has a sensor 31 that senses the identity of the sender of the signal 2. There is at least a register 32, and preferably also additional registers 33, 34. These registers include information about the identity of other subscribers to determine which calls 2 are permitted through to the first subscriber. The apparatus has a comparator 35. For example, when the register 32 is active while the other registers 33, 34 are inactive and when the register 32 includes the identity of the subscribers who are to be let through, the comparator 35 may be arranged to let through calls 2 when the identity information can be sensed by the sensor 31 and are included in the register 32 so that the call only reaches the telephone 1 when those two conditions are met.

In the alternative, the register 32 may be of a type that includes identity information about subscribers whose calls are not be let through to the telephone 1 of the first subscriber or only be let through to a message register 33 wherein the comparator 35 conducts the comparison.

As illustrated in FIG. 1, the arrangement may include a connection arrangement 36 to provide for a selective connection of one or many of the registers 32-34. In one embodiment, the connection arrangement 36 may be controlled by time, such as 24 hours, weekly, monthly etc. The registers 32-34 can include other different categories of the caller's access to each respective register.

The registers 32-34 may be such that the first subscribers may add and delete information in the registers. In a corresponding way, the connection arrangement 36 may be designed to be controlled or adapted by the first subscriber.

The arrangement 3 may be made as a separate unit which are marketed and sold to consumers for connection between the network/communication-signal. It is assumed that the first subscriber 1 is in agreement with the network/communication-signal operator that the operators shall include information in the signal of the incoming call regarding the identity of the caller.

It should be understood that the functions, that are illustrated in the arrangement 3, completely or partially be implemented in the equipment of the operator of the network/communication-signal. The first subscriber 1 may be able to program the registers 32-34 and the connection 36 via the network/communication signals of the operator if the first subscriber can show it has the authority to do so via for example the calling signal.

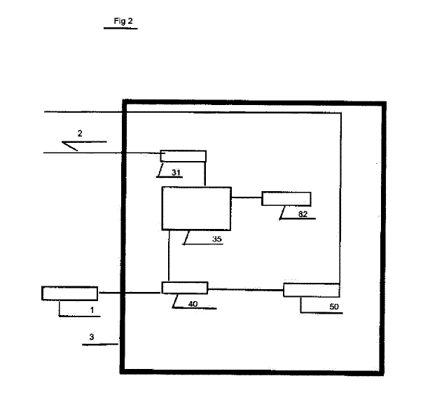

The embodiment of FIG. 2 is a further development of the customer concept so that the arrangement 40 is provided. Calls may be forwarded by the comparator 35 but that are not received by the switch 40 to a connecting arrangement 50 that forwards calls to another when the first subscriber is available.

In the alternative, the illustrated arrangement 50 may include prepared messages that are selectively distributed to the other callers.

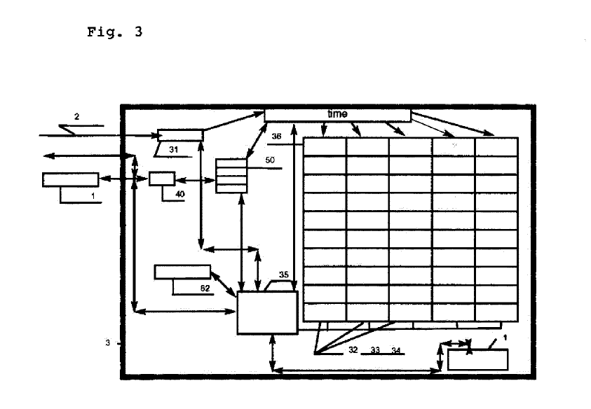

In another aspect of the invention, the calling subscribers may first get in contact with a message register that is arranged to give messages, sms or other message forms to calling subscribers so that the messages to the caller can be selective and adapted to the identity of the caller. The message register can be arranged to terminate the call after the message has been given. Thus, the register may forward calls from other subscribers that do not have messages for processing in the system according to FIGS. 1, 2 or 3. Furthermore, the register can be arranged to eliminate messages after they have passed a predetermined time control or after the message have been given so that later calls from the specific second subscriber is forwarded to the system according to FIGS. 1-3.

While the present invention has been described in accordance with preferred compositions and embodiments, it is to be understood that certain substitutions and alterations may be made thereto without departing from the spirit and scope of the following claims.

What is claimed is:

1. A method for letting telephone calls through to a first telephone subscribers from a group of subscribers subject to time controls followed by selective messages for other subscribers that have been selected in advance, the first subscriber receiving a call in a system for letting through calls to the first subscriber from a subscriber group that only includes in advance selected subscribers wherein a telephony system has a time control function and arranged to, via a selective message register that has information stored about the identity of a second subscriber and an additional register for desired calls wherein the identity of the second subscriber's call is added, the method comprising:
providing comparison means for comparing identity information that are included in a calling signal of the second subscriber to the first subscriber with identity information in a register for selected subscribers according to a register and arranging the comparison means to forwarding a call to the first subscriber only within permissible time periods and when the identity included in the calling signal is included in the register for desired callers and letting through calls during at least a time period for forwarding to selective messages where at least one register does not include information about the identify of the calling subscriber or forwarding the call to at least one register that has information about the identity of the calling subscriber and letting through the telephone call from the second subscriber to the first subscriber if the calling signal includes the identity of the caller and the identity exists in a register for this.

2. The method according to claim 1 wherein the method further comprises letting through call during many time periods to many selective messages.

3. The method according to claim 1 wherein the method further comprises providing selective messages with information about the identity of the second subscriber that is included in the calling signal and that is compared to a pre-programmed identity of the second subscriber and leaving a prerecorded message to each respective identity that is included in the calling signal.

4. The method according to claim 1 wherein the method further comprises providing time periods for letting through calls to selective messages when there is no information about the identity of the second subscriber and forwarding the calls to a register for storing information about the identity of desired other subscribers if there is information about the identity of the caller that lets the caller be connected to the first subscriber.

5. The method according to claim 4 wherein the method further comprises establishing many registers in different categories for desired calls when information about the identity of the second subscriber, when the time periods permit letting through of calls, and that the time period control determines which registers that are active during each time period.

6. The method according to claim 1 wherein the method further comprises the time periods controls the access of all functions.

7. A method for receiving a communication signal, comprising:
providing a receiving device of a first receiver for receiving an incoming signal from a first sender, the incoming signal having identity information of the first sender of the incoming signal;
a screening arrangement receiving the incoming signal;
a sensor in the screening arrangement sensing and identifying the identity information of the incoming signal;
a comparator in the screening arrangement comparing the identity information of the incoming signal with a list of approved identities; and
the screening arrangement passing the incoming signal to the receiving device of the first receiver only when the sensor identifies the identity information and the comparator finds identity information in the list that corresponds to the identity information of the first sender.

8. The method of claim 7 wherein the method further comprises a connection arrangement setting a first time period during which the incoming signal from the first sender is passable to the receiving device.

9. The method of claim 8 wherein the method further comprises the connection arrangement determining a time of receipt of the incoming signal.

10. The method of claim 9 wherein the method further comprises the connection arrangement passing the incoming signal to the receiving device only when the time of receipt is within the first time period.

11. The method of claim 9 wherein the method further comprises the connection arrangement blocking the incoming signal when the time of receipt is not within the first time period.

12. The method of claim 7 wherein the method further comprises the screening arrangement blocking the incoming signal when the sensor does not identify the identity information of the incoming signal.

13. The method of claim 7 wherein the method further comprises the screening arrangement blocking the incoming signal when the identity information is not found in the list.

14. The method of claim 7 wherein the method further comprises the comparator sending the incoming signal to a message center when the identity information of the incoming signal is not found in the list.

15. The method of claim 7 wherein the method further comprises the comparator sending the incoming signal to a first register responding with a first message when the identity information is related to the first sender and sending the incoming signal to a second register responding with a second message different from the first message when identity information is related to a second sender.

16. A method for receiving a communication signal, comprising:
providing a receiving device of a first receiver for receiving an incoming signal from a first sender, the incoming signal having identity information of a sender of the incoming signal;
a screening arrangement receiving the incoming signal;
a sensor in the screening arrangement sensing and identifying the identity information of the incoming signal;
a comparator in the screening arrangement comparing the identity information of the incoming signal with a blocking list of blocked identities; and
the screening arrangement passing the incoming signal to the receiving device of the first receiver when the sensor identifies the identity information and the comparator does not find the identity information of the sender in the blocking list.

17. The method of claim 16 wherein the method further comprises the screening arrangement blocking the incoming call when the identity information of the sender is not in the blocking list.

18. The method of claim 16 wherein the method further comprises the screening arrangement blocking the incoming signal when no identity information is identified.
